(19) United States
(12) Patent Application Publication
(10) Pub. No.: US 2009/0100238 A1
(43) Pub. Date: Apr. 16, 2009

(54) Memory card and memory card control changeover method

(76) Inventor: Masaharu Adachi, Osaka (JP)

Correspondence Address: DICKSTEIN SHAPIRO LLP, 1825 EYE STREET NW, Washington, DC, 20006-5403, US

(21) Appl. No.: 11/920,227

(22) PCT Filed: Mar. 12, 2007
(86) PCT No.: PCT/JP2007/055322

§ 371 Date: Nov. 13, 2007

(30) Foreign Application Priority Data
Mar. 14, 2006 (JP) 2006-069405

(51) Int. Cl. G06F 12/00; G06F 12/14

(52) U.S. Cl. 711/163; 711/154; 711/E12.001; 711/E12.091

(57) ABSTRACT

A disclosed memory card includes: a control unit; a nonvolatile memory; and a program memory, wherein the program memory stores control programs for plural standards, the control programs controlling data access between the nonvolatile memory and an external device as a memory card.

### TECHNICAL FIELD

The present invention relates to a memory card supporting plural standards and a changeover method thereof.

### BACKGROUND ART

Nonvolatile memory cards such as SD cards (registered trademark), MMCs (MultiMedia Card) (registered trademark), and the like have been used as information storage tools mutually used between mobile digital devices such as mobile phones, digital cameras, and the like, and digital devices such as PCs, printers, and the like.

The above-mentioned SD cards and MMCs as nonvolatile memory cards are similar in electric characteristics and card shape. However, both SD cards and MMCs are not completely compatible with each other in control methods and communication methods, so that there are cases where those nonvolatile memory cards of one type cannot be used in card insertion stages prepared for nonvolatile memory cards of the other type.

Further, conventional nonvolatile memory cards have a single nonvolatile memory card controller and this nonvolatile memory card controller is not completely compatible with a host controller of a nonvolatile memory card of a different standard. In addition, conventional nonvolatile memory cards are not provided with a changeover switch for nonvolatile memory card controllers or an internal program changeover unit.

Next, SD cards and MMCs are considered as an example. The SD cards and MMCs are compatible with each other in electric characteristics and card shape, so that it is possible to use the same control unit in both cards. Thus, although control instructions and protocols are not the same in both cards, it is possible to modify a function of one memory card to that of the other memory card when a control program in the memory card is modified. However, the modification of the control program in the memory card is substantially difficult.

Some host controllers (controllers on host computers) support memory cards of one of the SD cards and the MMCs. In this case, the host computer operates memory cards of one of the SD cards and the MMCs.

On the other hand, there are host controllers which support memory cards of both SD cards and MMCs. However, when memory cards not originally supported are inserted, namely, when a High-Speed MMC is inserted in an SD card host controller which only supports Standard MMCs, for example, data is transferred in a standard MMC method having a transmission rate lower than that of an SD card method. In this case, if it is possible to operate the MMC as an SD card, it is possible to transfer data at a higher transmission rate.

Patent Document 1 discloses a card device that switches internal controllers through detection of a status of a signal line and connects to a different interface through the use of an adapter. Specifically, the disclosed card device is intended to switch between a USB built in the SD card or MMC and a controller of the SD card or MMC, so that the SD card and the MMC are not switched. The present invention as will be described later is intended to support standards of different memory cards without using an adapter, so that the present invention is different from the invention disclosed in Patent Document 1. Patent Document 2 discloses an IC card detecting the status of a signal line or the standard of a memory card inserted with the use of an adapter so as to switch controllers. Although the controllers are installed for both SD card and MMC, a changeover method is dependent on hardware such as a pull-up resistance of the insertion adapter. Thus, this is different from the present invention described later in which a command transmitted from a host controller is analyzed and a controller in the memory card switches operations in software.

Patent Document 3 discloses detection and judgment of memory cards by the host controller. However, this is not related to changeover of controllers in the memory card. Patent 4 relates to integration of SD, MMC, and SIM. Patent Document 5 relates to an adapter for converting a mini-MMC shape into an SD card shape.

Patent Document 1: Japanese Laid-Open Patent Application No. 2005-115947

Patent Document 2: Japanese Laid-Open Patent Application No. 2005-284323

Patent Document 3: Japanese Patent No. 3655597

Patent Document 4: WO 01/084490

Patent Document 5: Japanese Utility Model Registration No. 3114194

### DISCLOSURE OF INVENTION

It is a general object of the present invention to provide an improved and useful nonvolatile memory card in which the above-mentioned problems are eliminated.

A more specific object of the present invention is to provide a nonvolatile memory card that can be used by a host controller and in a card insertion stage (in a host computer) for a nonvolatile memory of any standard when there are plural types of nonvolatile memory cards of different standards in which electric characteristics and card shapes are similar.

According to one aspect of the present invention, there is provided a memory card comprising: a control unit; a nonvolatile memory; and a program memory, wherein the program memory stores control programs for plural standards, the control programs controlling data access between the nonvolatile memory and an external device as a memory card.

According to another aspect of the present invention, there is provided a memory card comprising: a plurality of control units; a nonvolatile memory; and a write protect switch, wherein each of the plural control units controls data access between the nonvolatile memory and an external device in accordance with a standard as a different memory card, and the write protect switch is used as a changeover switch for selecting one of the plural control units.

According to another aspect of the present invention, there is provided a memory card comprising: a control unit; a nonvolatile memory; a program memory; and a write protect switch, wherein the program memory stores control programs for plural standards, the control programs controlling data access between the nonvolatile memory and an external device as a memory card, and the write protect switch is used as a changeover switch for selecting one of the plural control programs.

According to another aspect of the present invention, there is provided a memory card comprising: a control unit; a nonvolatile memory; a program memory; and a changeover switch, wherein the program memory stores control programs for plural standards, the control programs controlling data access between the nonvolatile memory and an external device as a memory card, and the control unit monitors a status of a signal from the changeover switch and executes a designated one of the control programs for the memory card in accordance with the status of the signal.

According to another aspect of the present invention, there is provided a memory card comprising: a control unit; a nonvolatile memory; a program memory; a changeover switch; and a reset signal obtaining circuit, wherein the program memory stores control programs for plural standards, the control programs controlling data access between the nonvolatile memory and an external device as a memory card, and when the reset signal obtaining circuit obtains a reset signal, the control unit receives a status of a signal from the changeover switch and executes a designated one of the control programs for the memory card in accordance with the status of the signal.

According to another aspect of the present invention, there is provided a memory card comprising: a control unit; a nonvolatile memory; a program memory; and a changeover switch, wherein the program memory stores control programs for plural standards, the control programs controlling data access between the nonvolatile memory and an external device as a memory card, and when the control unit obtains a specific instruction from the external device, the control unit receives a status of a signal from the changeover switch and executes a designated one of the control programs for the memory card in accordance with the status of the signal.

According to another aspect of the present invention, there is provided a memory card comprising: a control unit; a nonvolatile memory; and a program memory, wherein the program memory stores control programs for plural standards, the control programs controlling data access between the nonvolatile memory and an external device as a memory card, and the control unit monitors an instruction or a protocol received from the external device, selects one of the control programs in accordance with a specific instruction or protocol, and executes the selected control program for the memory card.

According to another aspect of the present invention, there is provided a memory card comprising: a control unit; a nonvolatile memory; and a program memory, wherein the program memory stores a command judgment program for judging each content of a command from an external device, a control program for common portions of memory cards, and control programs dedicated to memory cards for plural standards, the control program for common portions of memory cards is a control program for controlling data access between the nonvolatile memory and the external device as memory cards of plural standards, the control program for common portions of memory cards performing control on portions common to the memory cards of plural standards, and the control programs dedicated to memory cards are control programs for controlling data access between the nonvolatile memory and the external device as separate memory cards, the control programs dedicated to memory cards performing control dedicated to each memory card, and the control unit judges each content of the command from the external device in accordance with the command judgment program and selects and executes one of the control program for common portions of memory cards and the control programs dedicated to memory cards for plural standards.

According to the present invention the following effects are obtained.

First, with a single memory card, it is possible to support plural standards compatible in electric characteristics and in a card insertion stage. Further, it is possible to use the write protect switch, changeover switch, reset signal, or instruction from the host controller for selection from the control programs of plural standards, selection from the control units of plural standards, or selection of the memory cards. Moreover, it is possible to start each control to be performed from each instruction of the host controller.

Other objects, features and advantage of the present invention will become more apparent from the following detailed description when read in conjunction with the accompanying drawings.

### BRIEF DESCRIPTION OF DRAWINGS

FIG. 1 is a block diagram of an inside of a nonvolatile memory card according to a first embodiment of the present invention;

FIG. 2A is a block diagram of an inside of a nonvolatile memory card according to a second embodiment of the present invention in which a write protect switch is set to write enable;

FIG. 2B is a block diagram of an inside of a nonvolatile memory card according to the second embodiment of the present invention in which a write protect switch is set to write protect;

FIG. 3A is a block diagram of an inside of a nonvolatile memory card according to a third embodiment of the present invention in which a write protect switch is set to write enable;

FIG. 3B is a block diagram of an inside of a nonvolatile memory card according to the third embodiment of the present invention in which a write protect switch is set to write protect;

FIG. 4A is a block diagram of an inside of a nonvolatile memory card according to a fourth embodiment of the present invention;

FIG. 4B is a flowchart showing a process of an interrupt handling program in a nonvolatile memory card according to the fourth embodiment of the present invention in which a control program for a memory card is selected upon setting a changeover switch;

FIG. 5A is a block diagram of an inside of a nonvolatile memory card according to a fifth embodiment of the present invention;

FIG. 5B is a flowchart showing a process of an initialization program in a nonvolatile memory card according to the fifth embodiment of the present invention in which a control program for a memory card is selected upon resetting;

FIG. 6A is a block diagram of an inside of a nonvolatile memory card according to a sixth embodiment of the present invention;

FIG. 6B is a flowchart showing an operation of a control unit in a nonvolatile memory card according to the sixth embodiment of the present invention in which a control program for a memory card is selected upon receiving a reset command from a host controller;

FIG. 7A is a block diagram of an inside of a nonvolatile memory card according to a seventh embodiment of the present invention;

FIG. 7B is a flowchart showing an operation of a control unit in a nonvolatile memory card according to the seventh embodiment of the present invention in which a protocol from a host controller is analyzed and a control program for a memory card is selected;

FIG. 8 is a block diagram of an inside of a nonvolatile memory card according to an eighth embodiment of the present invention; and

FIG. 9 is a flowchart showing an operation of a control unit of a nonvolatile memory card according to the eighth embodiment of the present invention.

### BEST MODE FOR CARRYING OUT THE INVENTION

In the following, preferable embodiments according to the present invention are described with reference to the drawings.

In the present invention, control programs for plural standards are prepared in a single memory card and the control programs or control units in the memory card are switched as appropriate using an external changeover switch or an internal control program, thereby selecting a function optimal to a host controller.

In the present invention, forms and electric characteristics are assumed to be similar in the above-mentioned plural standards. In the following examples, an SD card and an MMC card are used. However, the present invention is not limited to these two types of cards.

### First Embodiment

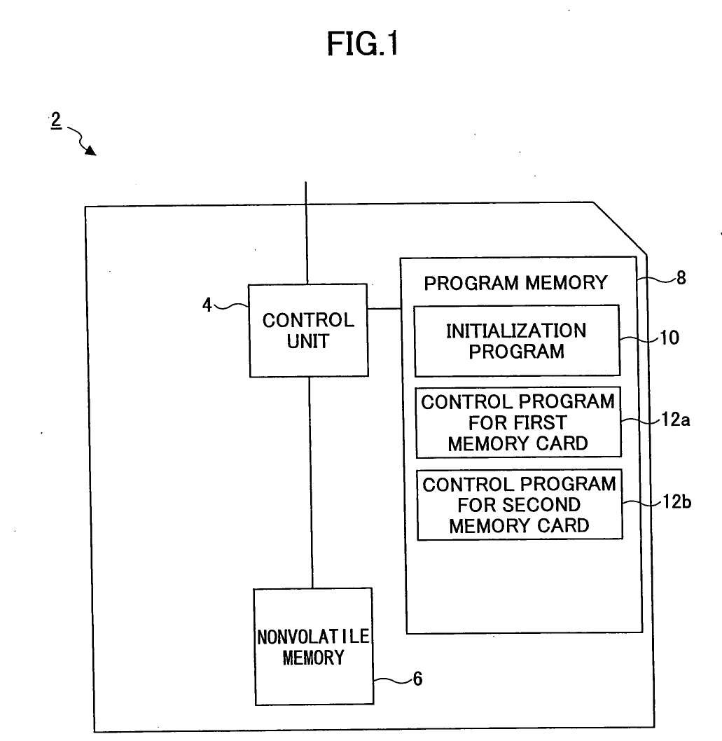

FIG. 1 is a block diagram of an inside of a nonvolatile memory card 2 according to a first embodiment of the present invention. In the nonvolatile memory card 2 according to the first embodiment of the present invention, there are disposed a control unit 4, a nonvolatile memory 6, and a program memory 8.

The nonvolatile memory card 2 according to the first embodiment is for performing data transfer between the nonvolatile memory 6 and the host controller (not shown in the drawings) via the control unit 4. The program memory 8 stores a control program 12a for a first memory card, a control program 12b for a second memory card, and an initialization program 10 as control programs.

The nonvolatile memory card 2 according to the first embodiment is capable of executing one of the control programs (12a and 12b) for the first memory card and the second memory card after the initialization program 10 is operated. For example, when a control program for an SD card or a control program for an MMC is operated, the nonvolatile memory card 2 is capable of operating as the SD card or the MMC. A method and mechanism of selection and operation is described from a third embodiment.

### Second Embodiment

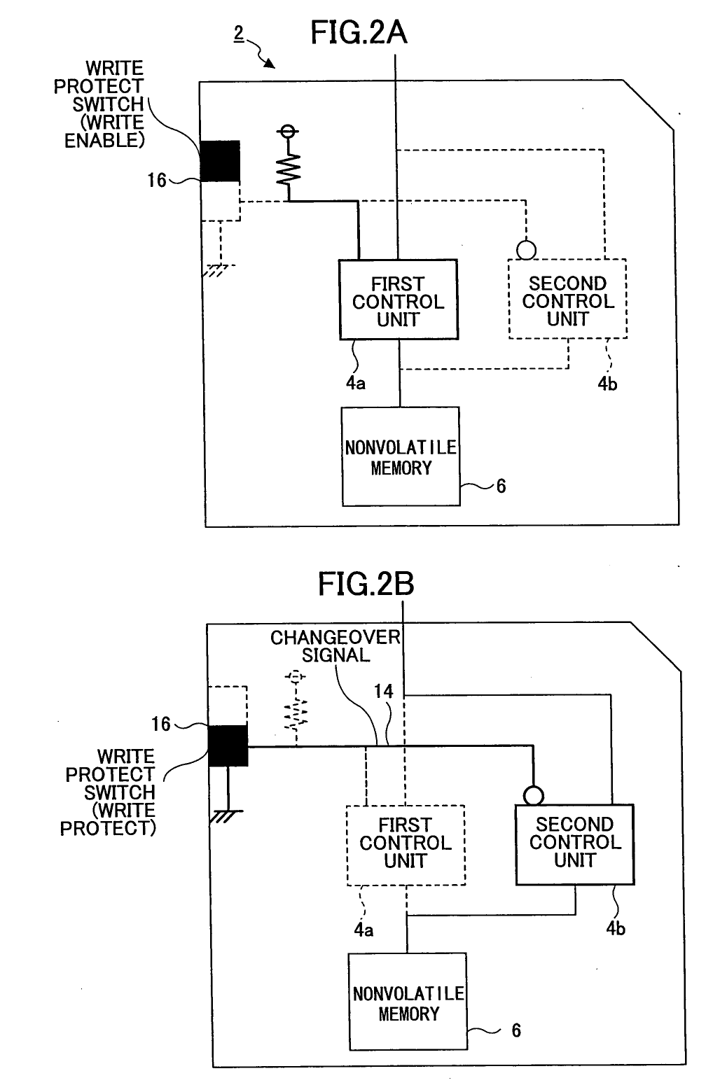

FIGS. 2A and 2B are block diagrams of the inside of the nonvolatile memory card 2 according to a second embodiment of the present invention. In the nonvolatile memory card 2 according to the second embodiment, there are disposed a first control unit 4a, a second control unit 4b, the nonvolatile memory 6, and a write protect switch 16.

The nonvolatile memory card 2 according to the second embodiment is for performing data transfer between the nonvolatile memory 6 and the host controller (not shown in the drawings) via the control unit (the first control unit 4a or the second control unit 4b). The nonvolatile memory card 2 includes the first control unit 4a for the first memory card and the second control unit 4b for the second memory card. Types of control unit may be increased.

In the nonvolatile memory card 2 according to the second embodiment, the write protect switch 16 supports writing and protection for the first memory card. However, the write protect switch 16 does not support writing and protection for the second memory card.

First, as shown in FIG. 2A, the nonvolatile memory card 2 is configured such that when the write protect switch 16 is set to write enable, the first control unit 4a is set in operation at the same time. In this case, the host controller is capable of performing data transfer with the nonvolatile memory card 2 using a method for the first memory card. Further, because the write protect switch 16 is set to write enable, the host controller is capable of writing data on the memory card as the first memory card.

Next, as shown in FIG. 2B, the nonvolatile memory card 2 is configured such that when the write protect switch 16 is set to write protect, the second control unit 4b is set in operation at the same time. In this case, the host controller is capable of performing data transfer with the nonvolatile memory card 2 using a method for the second memory card. Further, although the write protect switch 16 is set to write protect, writing and protection for the second memory card is not supported (namely, setting is disregarded), so that the host controller is capable of writing data on the memory card as the second memory card.

As an example, a memory card including a control unit for the SD card and a control unit for the MMC is described. The SD card corresponds to the above-mentioned first memory card and the MMC corresponds to the above-mentioned second memory card. First, when an operation as the SD card is selected, the write protect switch 16 is set to write enable. In this case, the host controller is capable of performing data transfer with the nonvolatile memory card 2 in an SD card method. The write protect switch 16 is set to write enable, so that the host controller is capable of writing data on the nonvolatile memory card 2.

When an operation as the MMC is selected, the write protect switch 16 is set to write protect. In this case, the host controller is capable of performing data transfer with the nonvolatile memory card 2 in an MMC method. The setting of the write protect switch 16 is disregarded, so that the host controller is capable of writing data on the nonvolatile memory card 2.

The nonvolatile memory card 2 according to the second embodiment uses a function of the write protect in the write protect switch 16 as a changeover between the control units for the memory card. Thus, a function of a changeover switch is provided without adding a physical changeover switch.

### Third Embodiment

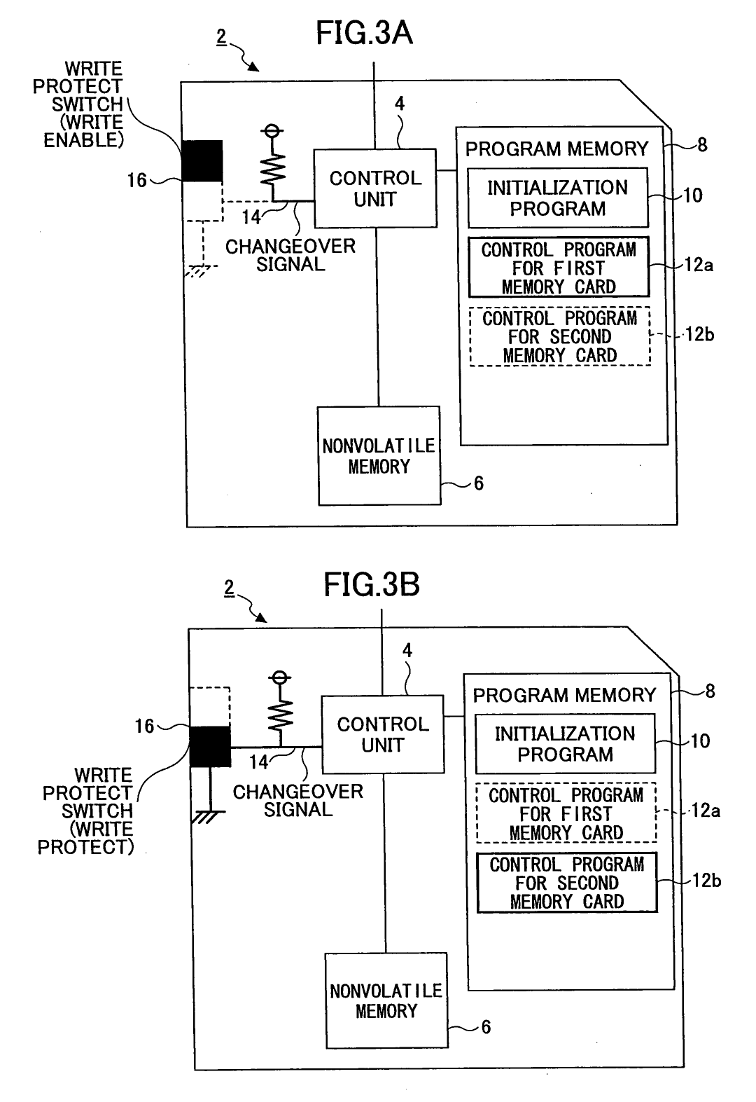

FIGS. 3A and 3B are block diagrams of the inside of the nonvolatile memory card 2 according to the third embodiment of the present invention. In the nonvolatile memory card 2 according to the third embodiment of the present invention, there are disposed the control unit 4, the nonvolatile memory 6, and the program memory 8.

The nonvolatile memory card 2 according to the third embodiment is also for performing data transfer between the nonvolatile memory 6 and the host controller (not shown in the drawings) via the control unit 4. The program memory 8 stores the control program 12a for the first memory card, the control program 12b for the second memory card, and the initialization program 10 as control programs.

In the nonvolatile memory card 2 according to the third embodiment, the write protect switch 16 supports writing and protection for the first memory card. However, the write protect switch 16 does not support writing and protection for the second memory card.

First, as shown in FIG. 3A, the nonvolatile memory card 2 is configured such that when the write protect switch 16 is set to write enable, the control program 12a for the first memory card is selected by the initialization program at the same time. In this case, the host controller is capable of performing data transfer with the nonvolatile memory card 2 using the method for the first memory card. Further, the write protect switch 16 is set to write enable, so that the host controller is capable of writing data on the memory card as the first memory card.

Next, as shown in FIG. 3B, the nonvolatile memory card 2 is configured such that when the write protect switch 16 is set to write protect, the control program 12b for the second memory card is selected by the initialization program at the same time. In this case, the host controller is capable of performing data transfer with the nonvolatile memory card 2 using the method for the second memory card. Further, although the write protect switch 16 is set to write protect, writing and protection for the second memory card is not supported (namely, setting is disregarded), so that the host controller is capable of writing data on the memory card as the second memory card.

As an example, a memory card including a control program for the SD card and a control program for the MMC is described. The SD card corresponds to the above-mentioned first memory card and the MMC corresponds to the above-mentioned second memory card. First, when an operation as the SD card is selected, the write protect switch 16 is set to write enable. In this case, the host controller is capable of performing data transfer with the nonvolatile memory card 2 in the SD card method. The write protect switch 16 is set to write enable, so that the host controller is capable of writing data on the nonvolatile memory card 2.

When an operation as the MMC is selected, the write protect switch 16 is set to write protect. In this case, the host controller is capable of performing data transfer with the nonvolatile memory card 2 in the MMC method. The setting of the write protect switch 16 is disregarded, so that the host controller is capable of writing data on the nonvolatile memory card 2.

The nonvolatile memory card 2 according to the third embodiment uses the function of the write protect in the write protect switch 16 as a changeover between the control units for the memory card in the same manner as in the second embodiment. Thus, a function of a changeover switch is provided without adding a physical changeover switch.

The nonvolatile memory card 2 according to the third embodiment has a single control unit. Thus, a cost is reduced in comparison with the memory card according to the second embodiment in which plural control units are installed.

### Fourth Embodiment

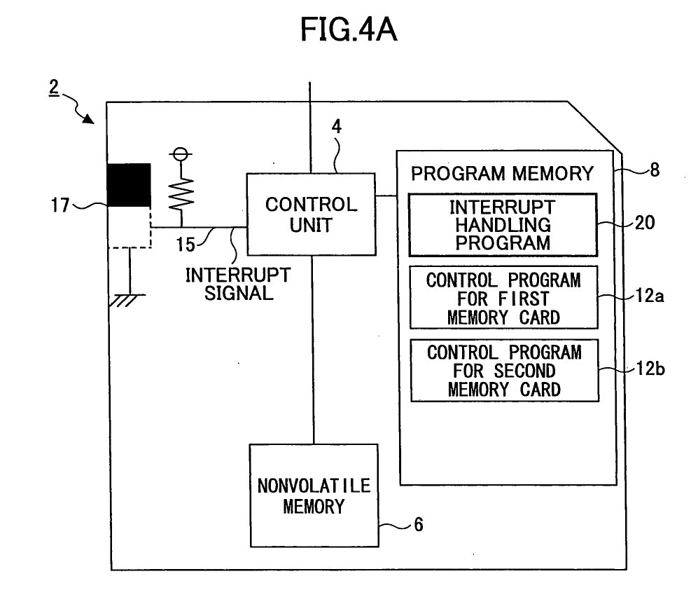

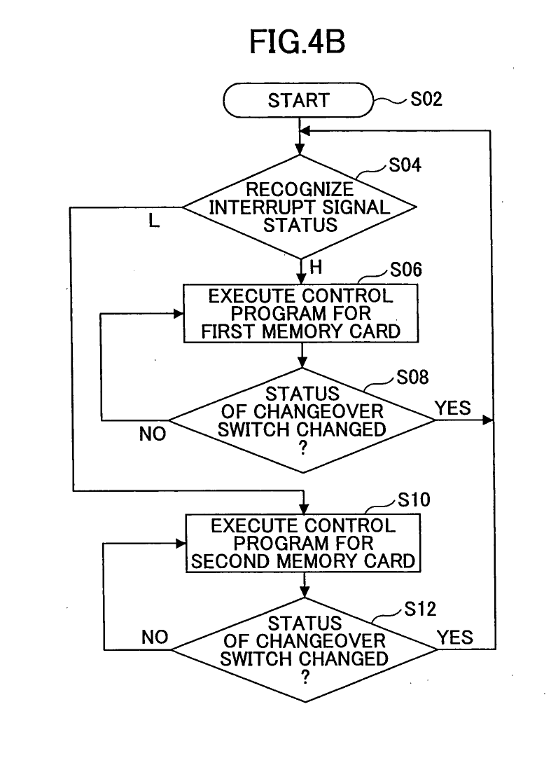

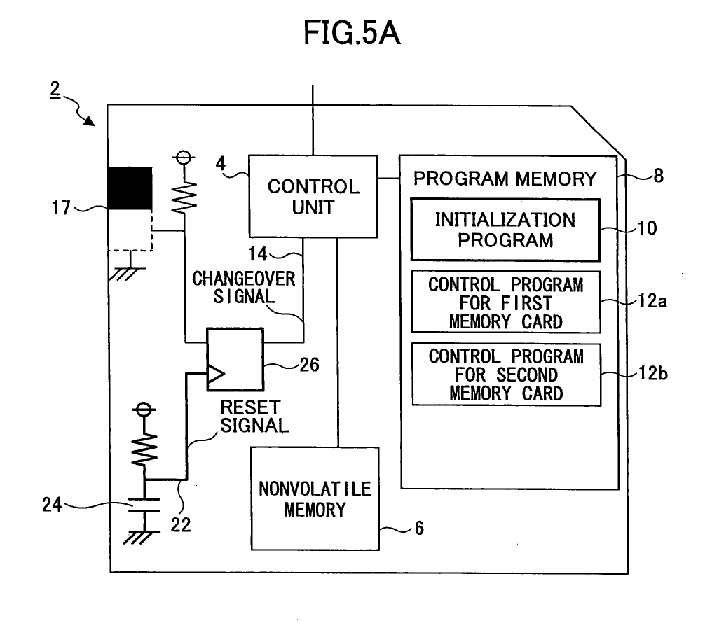

FIG. 4A is a block diagram of the inside of the nonvolatile memory card 2 according to a fourth embodiment of the present invention. The nonvolatile memory card according to the fourth embodiment is substantially the same as the nonvolatile memory card according to the third embodiment. Thus, the same reference numerals are provided to the same portions and description thereof is omitted.

In the nonvolatile memory card according to the third embodiment, a time of changeover of control programs is not specifically defined. The nonvolatile memory card 2 according to the fourth embodiment defines a time when a changeover switch 17 is used as a time for changeover from one control program to another control program. In this case, the changeover switch 17 is disposed on the nonvolatile memory card 2 according to the fourth embodiment and the changeover switch 17 issues an interrupt signal. In addition, the write protect switch 16 may be used as the changeover switch 17.

First, as shown in FIG. 4A, when the nonvolatile memory card 2 is used to operate as the first memory card, the changeover switch 17 is set to “open”. In this case, an interrupt is generated at a time of changeover and an interrupt handling program 20 stored in the program memory 8 selects the control program 12a for the first memory card. In accordance with this, the host controller is capable of performing data transfer with the nonvolatile memory card 2 in the first memory card method.

Next, when the nonvolatile memory card 2 is used to operate as the second memory card, the changeover switch 17 is set to “closed”. In this case, an interrupt is also generated at the time of changeover and the interrupt handling program 20 stored in the program memory 8 selects the control program 12b for the second memory card. In accordance with this, the host controller is capable of performing data transfer with the nonvolatile memory card 2 in the second memory card method.

FIG. 4B is a flowchart showing a process of the interrupt handling program 20 for selecting the control program for the memory card upon setting the changeover switch 17. Immediately after a start of the flowchart (immediately after power-on, mostly) (S02), the interrupt handling program 20 judges a status of an interrupt signal 15 from the changeover switch 17 (S04) and the control program for the first memory card or the control program for the second memory card is executed (S06, S10). In addition, reference “H” in S04 of the FIG. 4B corresponds to an “open” status and reference “L” corresponds to a “closed” status of the changeover switch 17.

While the control program 12a for the first memory card or the control program 12b for the second memory card is executed (S06, S10), when the status of the changeover switch 17 is changed (YES in S08, YES in S12), the interrupt handling program 20 judges the status of the interrupt signal 15 (S04) and the control program for the first memory card or the control program for the second memory card is executed (S06, S10).

As an example, a memory card including the control program for the SD card and the control program for the MMC is described. The SD card corresponds to the above-mentioned first memory card and the MMC corresponds to the above-mentioned second memory card. First, when an operation as the SD card is selected, the changeover switch 17 is set to “open”. In this case, an interrupt is generated at the time of changeover and the interrupt handling program 20 selects the control program for the SD card. The host controller is capable of performing data transfer with the nonvolatile memory card 2 in the SD card method.

When an operation as the MMC is selected, the changeover switch 17 is set to “closed”. In this case, an interrupt is generated at a time of changeover and the interrupt handling program 20 selects the control program for the MMC. The host controller is capable of performing data transfer with the nonvolatile memory card 2 in the MMC method.

In the nonvolatile memory card 2 according to the fourth embodiment, interrupt handling is performed in accordance with the changeover of setting by the changeover switch 17. Thus, even when the changeover switch 17 is set from an erroneous operation and the like, supported memory card methods are used and malfunction is prevented.

### Fifth Embodiment

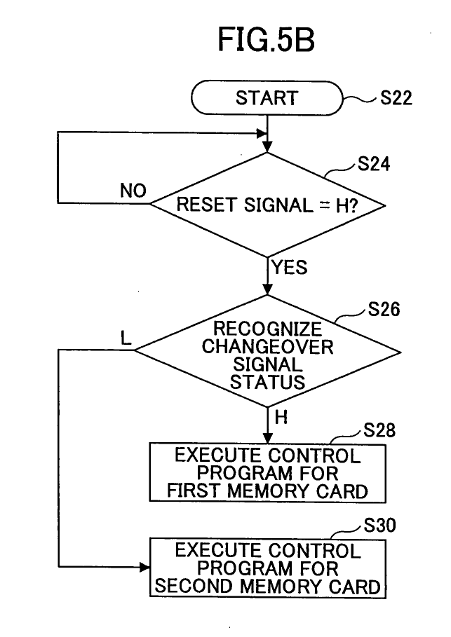

FIG. 5A is a block diagram of the inside of the nonvolatile memory card 2 according to a fifth embodiment of the present invention. The nonvolatile memory card according to the fifth embodiment is substantially the same as the nonvolatile memory card according to the fourth embodiment. Thus, the same reference numerals are provided to the same portions and description thereof is omitted. In the nonvolatile memory card 2 according to the fifth embodiment, the changeover switch 17 emits a changeover signal 14. In addition, the write protect switch 16 may be used as the changeover switch 17.

The nonvolatile memory card 2 according to the fifth embodiment sets the control program for the memory card using a reset upon power-on. A flip-flop circuit 26 is internally or externally disposed on the control unit 4 of the nonvolatile memory card 2. Regarding data input to the flip-flop circuit 26, the changeover signal 14 of the changeover switch 17 is input and a reset signal 22 is input for clock input. An output therefrom is used as a changeover signal for the control programs by the control unit 4. In addition, the reset signal 22 may be used to reset the control unit 4.

First, when the nonvolatile memory card 2 is used to operate as the first memory card, the changeover switch 17 is set to “open”. In this case, at a time when the reset signal 22 is “H” due to power-on of the nonvolatile memory card, the initialization program selects the control program for the first memory card. In accordance with this, the host controller is capable of performing data transfer with the nonvolatile memory card 2 in the first card memory method.

Next, when the nonvolatile memory card 2 is used to operate as the second memory card, the changeover switch 17 is set to “closed”. In this case, at a time when the reset signal 22 is “H” due to power-on of the nonvolatile memory card, the initialization program selects the control program for the second memory card. In accordance with this, the host controller is capable of performing data transfer with the nonvolatile memory card 2 in the second card memory method.

FIG. 5B is a flowchart showing a process of the initialization program for selecting the control program for the memory card upon resetting. The initialization program 10 judges a status of the changeover signal 14 (H or L in S26) at the time when the reset signal 22 is “H” (YES in S24), and then the control program 12a for the first memory card or the control program 12b for the second memory card is executed (S28, S30). In other words, only when a reset is generated, the control program to be executed is selected in accordance with the status of the changeover switch 17.

As an example, a memory card including the control program for the SD card and the control program for the MMC is described. The SD card corresponds to the above-mentioned first memory card and the MMC corresponds to the above-mentioned second memory card. First, when an operation as the SD card is selected, the changeover switch 17 is set to “open”. In this case, at the time when the reset signal 22 is “H” due to power-on of the nonvolatile memory card, the control program for the SD card is selected by the initialization program 10. The host controller is capable of performing data transfer with the nonvolatile memory card 2 in the SD card method.

When an operation as the MMC is selected, the changeover switch 17 is set to “closed”. In this case, at the time when the reset signal 22 is “H” due to power-on of the nonvolatile memory card, the initialization program 10 selects the control program for the MMC. The host controller is capable of performing data transfer with the nonvolatile memory card 2 in the MMC method.

In the nonvolatile memory card 2 according to the fifth embodiment, the control program is set with the use of the reset signal after power-on of the memory card. Thus, setting of the control program is not changed unless the reset signal is generated. Even when the changeover switch is used, the standard of the memory card remains fixed.

### Sixth Embodiment

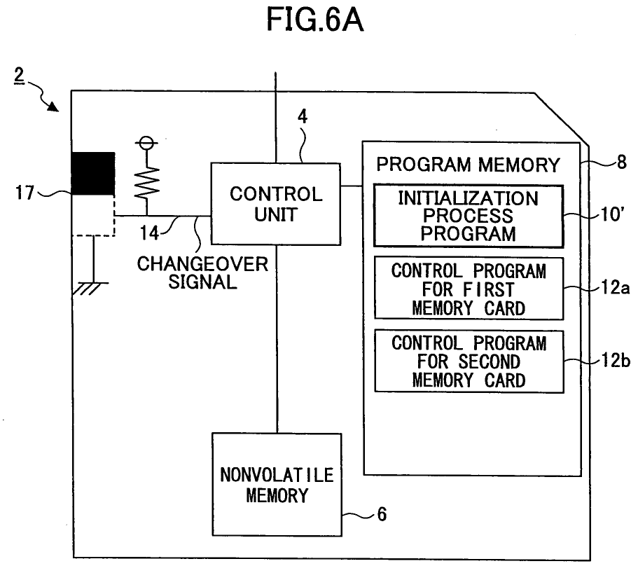

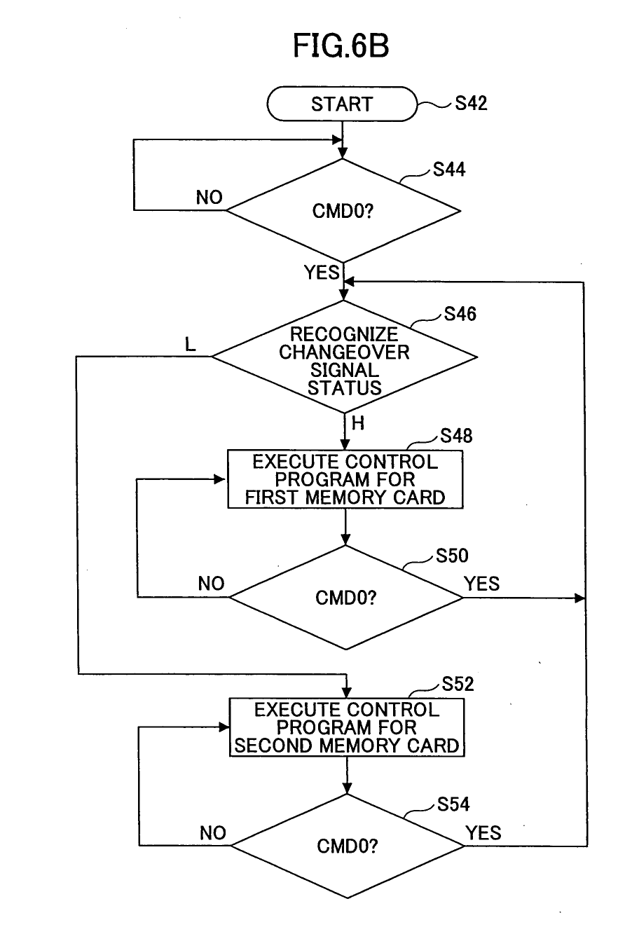

FIG. 6A is a block diagram of the inside of the nonvolatile memory card 2 according to a sixth embodiment of the present invention. The nonvolatile memory card according to the sixth embodiment is substantially the same as the nonvolatile memory card according to the fifth embodiment. Thus, the same reference numerals are provided to the same portions and description thereof is omitted.

In the nonvolatile memory card 2 according to the sixth embodiment, an initialization process program 10′ and the control programs incorporate codes for analyzing a reset command from the host controller.

First, when the nonvolatile memory card 2 is used to operate as the first memory card, the changeover switch 17 is set to “open”. In this case, at a time when the control unit 4 receives the reset command from the host controller, the initialization process program 10′ or the control program selects the control program for the first memory card. In accordance with this, the host controller is capable of performing data transfer with the nonvolatile memory card 2 in the first memory card method.

Next, when the nonvolatile memory card 2 is used to operate as the second memory card, the changeover switch 17 is set to “closed”. In this case, at a time when the control unit 4 receives the reset command from the host controller, the initialization process program 10′ or the control program selects the control program for the second memory card. In accordance with this, the host controller is capable of performing data transfer with the nonvolatile memory card 2 in the second memory card method.

FIG. 6B is a flowchart showing an operation of a control unit selecting the control program for the memory card upon receiving the reset command from the host controller. First, when the initialization process program 10′ receives the reset commend (YES in S44), a status of the changeover signal is recognized (S46), and the control program 12a for the first memory card is executed (S48) or the control program 12b for the second memory card is executed (S52). In addition, in the changeover signal, reference “H” indicates setting for the first memory card and reference “L” indicates setting for the second memory card.

Even while one of the control programs is executed, when the control program receives the reset command, (YES in S50, YES in S54), the status of the changeover signal is recognized (S46) and one of the control program 12a for the first memory card (S48) and the control program 12b for the second memory card (S52) is executed again.

As an example, a memory card including the control program for the SD card and the control program for the MMC is described. The SD card corresponds to the above-mentioned first memory card and the MMC corresponds to the above-mentioned second memory card. First, when an operation as the SD card is selected, the changeover switch 17 is set to “open”. In this case, at a time when “CMD0” is received as the reset commend from the host controller, the initialization process program 10′ or the control program selects the control program for the SD card. The host controller is capable of performing data transfer with the nonvolatile memory card 2 in the SD card method.

When an operation as the MMC is selected, the changeover switch 17 is set to “closed”. In this case, at the time when “CMD0” is received as the reset commend from the host controller, the initialization process program 10′ or the control program selects the control program for the MMC. The host controller is capable of performing data transfer with the nonvolatile memory card 2 in the MMC method.

In the nonvolatile memory card 2 according to the sixth embodiment, the control program is set with the use of the reset command of the host controller for initializing the memory card. Thus, setting of the control program is not changed unless the reset command is generated. Even when the changeover switch is used due to some kind of cause, the standard of the memory card remains fixed.

### Seventh Embodiment

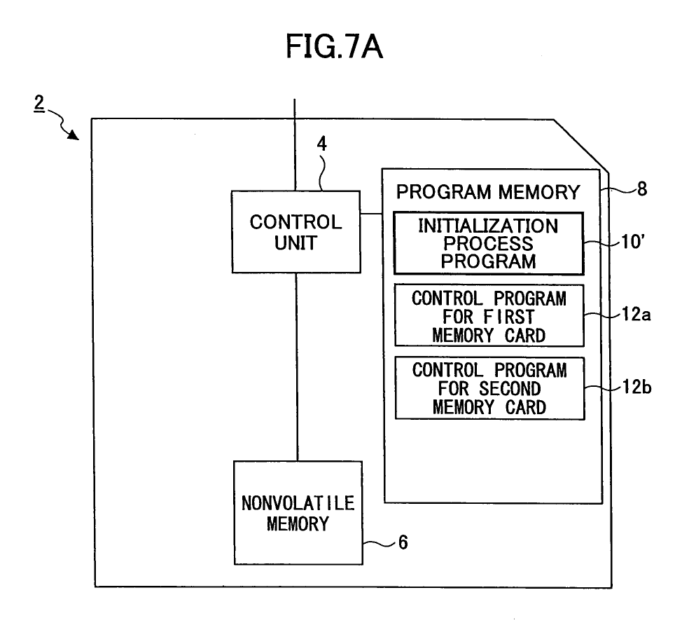

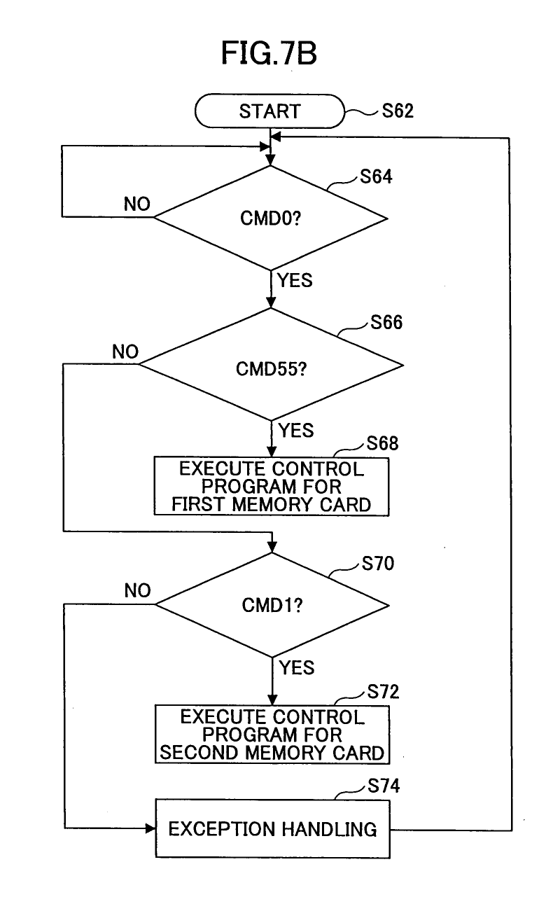

FIG. 7A is a block diagram of the inside of the nonvolatile memory card 2 according to a seventh embodiment of the present invention. The nonvolatile memory card according to the seventh embodiment is substantially the same as the nonvolatile memory card according to the sixth embodiment. Thus, the same reference numerals are provided to the same portions and description thereof is omitted.

In the nonvolatile memory card 2 according to the seventh embodiment, the changeover switch is not disposed. In the nonvolatile memory card 2 according to the seventh embodiment, a protocol transmitted from the host controller (not shown in the drawings) is analyzed and setting of the control program is performed.

In the nonvolatile memory card 2 according to the seventh embodiment, the initialization process program 10′ and the control programs incorporate codes for analyzing an access procedure for initializing the memory card from the host controller.

First, the initialization process program 10′ analyzes the protocol from the host controller. When the protocol is judged to be for the first memory card, the initialization process program 10′ selects the control program 12a for the first memory card. The host controller is capable of performing data transfer with the nonvolatile memory card 2 in the first memory card method.

Next, the initialization process program 10′ analyzes the protocol from the host controller. When the protocol is judged to be for the second memory card, the initialization process program 10′ selects the control program 12b for the second memory card. The host controller is capable of performing data transfer with the nonvolatile memory card 2 in the second memory card method. When the protocol is judged to be irrelevant to both memory cards, exception handling is performed to continue the protocol analysis.

FIG. 7B is a flowchart showing an operation of the control unit analyzing the protocol from the host controller and selecting the control program for the memory card. First, when the initialization process program 10′ (or the control program) receives the reset command (CMD0, for example) (YES in S64), whether the protocol is for the first memory card is judged. When the protocol is judged to be for the first memory card (YES in S66), the control program 12a for the first memory card is selected and executed (S68). When the protocol is judged to be for the second memory card (NO in S66, YES in S70), the control program 12b for the second memory card is selected and executed (S72). When the protocol is judged to be irrelevant to both memory cards (NO in S70), exception handling is performed (S74) and the process further awaits the reset command.

As an example, a memory card including the control program for the SD card and the control program for the MMC is described. The SD card corresponds to the above-mentioned first memory card and the MMC corresponds to the above-mentioned second memory card. First, at a time when the initialization process program 10′ (or the control program) successively receives CMD0 and CMD55, the initialization process program 10′ or the control program selects the control program for the SD card. The host controller is capable of performing data transfer with the nonvolatile memory card 2 in the SD card method.

At a time when the initialization process program 10′ (or the control program) successively receives CMD0 and CMD1, the initialization process program 10′ or the control program selects the control program for the MMC. The host controller is capable of performing data transfer with the nonvolatile memory card 2 in the MMC method.

In the nonvolatile memory card 2 according to seventh embodiment, the initialization process program 10′ or the control program analyzes the protocol from the host controller and sets the control program, so that the changeover switch is unnecessary.

In addition, although the number of the control programs is two in this embodiment, more than two control programs for memory cards may be prepared used through changeover. In this case, the necessity of adding the changeover switch as in the first to the sixth embodiments is eliminated.

### Eighth Embodiment

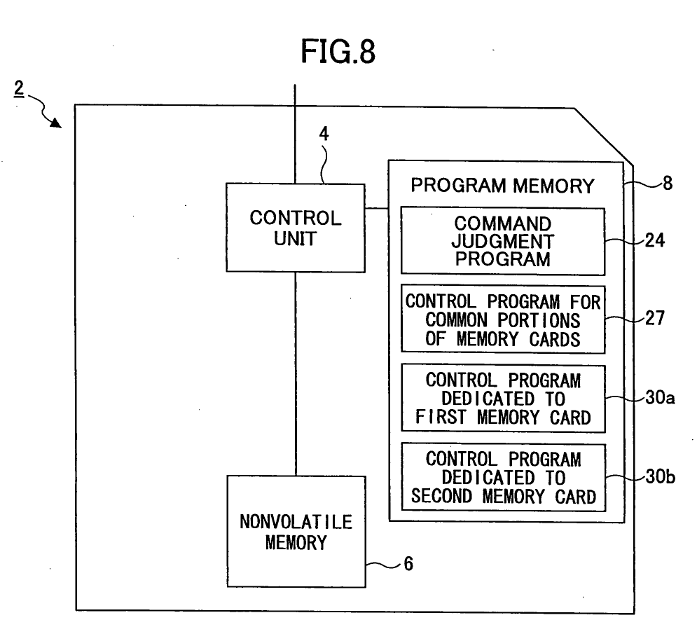

FIG. 8 is a block diagram of the inside of the nonvolatile memory card 2 according to an eighth embodiment of the present invention. The nonvolatile memory card according to the eighth embodiment is substantially the same as the nonvolatile memory card according to the seventh embodiment. Thus, the same reference numerals are provided to the same portions and description thereof is omitted.

In the nonvolatile memory card 2 according to the eighth embodiment, the changeover switch is not disposed. Further, the changeover of the control programs is not performed. However, data transfer with host controllers of plural standards is possible.

The nonvolatile memory card 2 according to the eighth embodiment is for performing data transfer between the nonvolatile memory 6 and the host controller (not shown in the drawings) via the control unit 4. The program memory 8 stores a command judgment program 24, a control program for common portions of memory cards 27, a control program dedicated to the first memory card 30a, and a control program dedicated to the second memory card 30b.

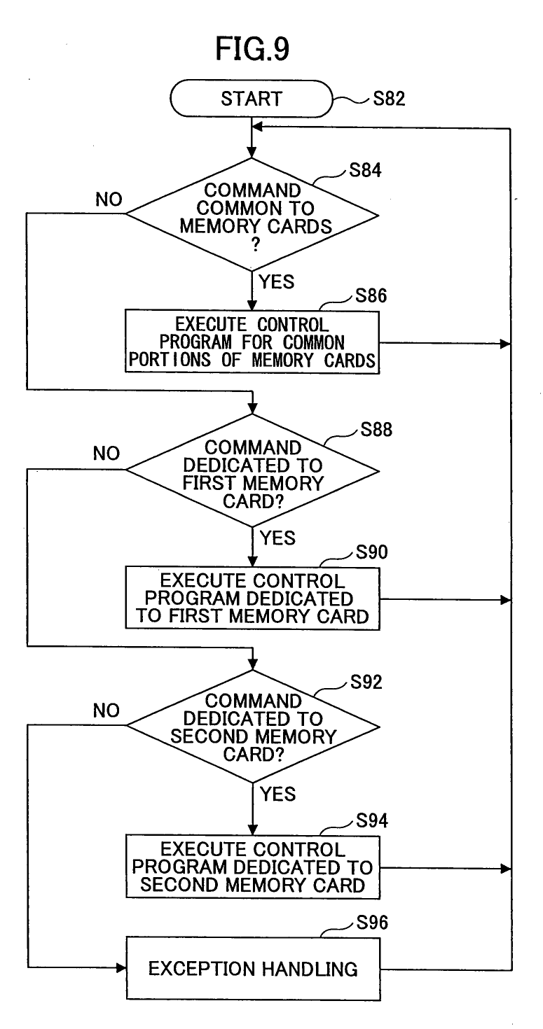

FIG. 9 is a flowchart showing an operation of the control unit 4 of the nonvolatile memory card 2. First, when a command is received from the host controller, the command judgment program 24 judges contents of the command. When the command is common to all memory cards (YES in S84), the command is transferred to the control program for common portions of memory cards 27. After the control program for common portions of memory cards 27 has performed processing (S86), the process returns to the judgment of the command judgment program 24 again.

When the command is dedicated to the first memory card (NO in S84, YES in S88), the command is transferred to the control program dedicated to the first memory card 30a. After the control program dedicated to the first memory card 30a has performed processing (S90), the process returns to the judgment of the command judgment program 24.

When the command is dedicated to the second memory card (NO in S84, NO in S88, YES in S92), the command is transferred to the control program dedicated to the second memory card 30b. After the control program dedicated to the second memory card 30b has performed processing (S94), the process returns to the judgment of the command judgment program 24.

When the command is judged to be irrelevant to any protocol (NO in S84, NO in S88, NO in S92), exception handling is performed (S96) and the process returns to the judgment of the command judgment program 24.

As an example, a memory card including a command judgment program, a control program for common portions of the SD card and the MMC, a control program dedicated to the SD card, and a control program dedicated to the MMC is described.

First, a case where the nonvolatile memory card 2 is inserted into a slot dedicated to SD cards in a host computer (not shown in the drawings) is described. When a command is received from an SD card host controller, the command judgment program judges the command. When the command is common to all memory cards, the command is transferred to the control program for common portions. After the control program for common portions has performed processing, the process returns to the judgment of the command judgment program again.

When the command is dedicated to the SD card, the command is transferred to the control program dedicated to the SD card. After the control program dedicated to the SD card has performed processing, the process returns to the judgment of the command judgment program again. In this case, the SD card host controller accesses the memory card according to the present invention as an SD card since the memory card according to the present invention normally responds to all commands supported by the SD cards. Further, the host controller is for the SD card, so that a command dedicated to the MMC is not transmitted, so that the command is not transmitted to the control program dedicated to the MMC.

Next, a case where the nonvolatile memory card 2 is inserted into a slot dedicated to MMCs in the host computer (not shown in the drawings) is described. When a command is received from an MMC host controller, the command judgment program judges the command. When the command is common to all memory cards, the command is transferred to the control program for common portions. After the control program for common portions has performed processing, the process returns to the judgment of the command judgment program again.

When the command is dedicated to the MMC, the command is transferred to the control program dedicated to the MMC. After the control program dedicated to the MMC has performed processing, the process returns to the judgment of the command judgment program again. In this case, the MMC host controller accesses the memory card according to the present invention as an MMC since the memory card according to the present invention normally responds to all commands supported by the MMCs. Further, the host controller is for the MMC, so that a command dedicated to the SD card is not transmitted, so that the command is not transmitted to the control program dedicated to the SD card.

Further, a case where the nonvolatile memory card 2 is inserted into a slot compatible with SD cards and MMCs is described. In a case of a host controller supporting both SD cards and MMCs, the host controller is required to judge whether the inserted memory card is an SD card or an MMC. In this case, the host controller transmits a command supported exclusively by the SD card or the MMC and recognizes a response so as to judge the inserted memory card.

For example, when the host controller successively transmits “CMD0” and “CMD1” and a normal response is returned, the host controller judges the memory card as the MMC, and when the host controller successively transmits “CMD0” and “CMD55” and a normal response is returned, the host controller judges the memory card as the SD card.

When the host controller successively transmits commands dedicated to the SD card such as “CMD0” and “CMD55”, for example, the memory card according to the present invention returns a normal response. In this case, the host controller judges the inserted memory card to be the SD card. Thereafter, the host controller accesses the memory card using commands supported exclusively by the SD card. In this case, the memory card according to the present invention returns a normal response to the commands supported by the SD card, so that data transmission between the host controller and the memory card according to the present invention is normally performed.

In the same manner, when the host controller judges the memory card using a command dedicated to the MMC, the memory card according to the present invention normally operates as the MMC.

In the nonvolatile memory card 2 according to the eighth embodiment, it is possible to share the control program except the control programs for commands dedicated to each standard. Thus, a total size of the control programs is reduced. Further, changeover of control programs is unnecessary, so that the necessity of the changeover switch is eliminated.

In this example of the embodiment, although the number of the control programs is two, control programs dedicated to more than two memory cards may be prepared for changeover. In this case, the necessity of the changeover switch as in the first to the sixth embodiments is eliminated.

In the above-mentioned memory card, SDHC standard may be used instead of the MMC standard.

Further, the above-mentioned control program may store the SDHC standard instead of the MMC standard.

Moreover, the above-mentioned control unit may execute the control program storing the SDHC standard instead of the MMC standard.

The present invention is not limited to the specifically disclosed embodiment, and variations and modifications may be made without departing from the scope of the present invention.

The present application is based on Japanese priority application No. 2006-069405 filed Mar. 14, 2006, the entire contents of which are hereby incorporated herein by reference.

1-39. (canceled)

40. A memory card comprising:
at least one control unit; and
a nonvolatile memory, wherein
said memory card includes plural standards for controlling data access between said nonvolatile memory and an external device as a memory card.

41. The memory card of claim 40, said memory card further comprising:
a program memory, wherein
said program memory stores control programs for plural standards, the control programs controlling data access between said nonvolatile memory and an external device as a memory card.

42. The memory card of claim 40,
said at least one control unit comprising a plurality of control units, and
said memory card further comprising a write protect switch, wherein
each of said plurality of control units controls data access between said nonvolatile memory and an external device in accordance with a standard as a different memory card, and
said write protect switch is used as a changeover switch for selecting one of said plurality of control units.

43. The memory card of claim 41, said memory card further comprising a changeover switch such as a write-protect switch, wherein said at least one control unit monitors a status of a signal from said changeover switch and executes a designated one of the plurality of control programs for said memory card in accordance with the status of the signal.

44. A computer-readable program executed by a computer serving as a control unit of a memory card,
said memory card including:
said control unit;
a nonvolatile memory; and
a program memory, wherein
said program memory stores control programs for plural standards, the control programs controlling data access between said nonvolatile memory and an external device as a memory card, and
computer-readable program causing the computer to perform a process comprising executing a designated one of the control programs.

45. The program of claim 44,
said memory card further including a changeover switch such as a write-protect switch,
said process further comprising:
monitoring a status of a signal from said changeover switch; and
executing a designated one of the control programs for said memory card in accordance with the status of the signal.

46. The memory card of claim 41, said memory card further comprising a changeover switch such as a write-protect switch, wherein when said at least one control unit obtains a specific instruction from the external device, said control unit receives a status of a signal from said changeover switch and executes a designated one of the plurality of control programs for said memory card in accordance with the status of the signal.

47. The computer-readable program of claim 45, the step of monitoring a status of a signal from said changeover switch further comprising receiving a status of a signal from said changeover switch when said control unit obtains a specific instruction from the external device.

48. The memory card of claim 41, wherein said at least one control unit monitors an instruction or a protocol received from the external device, selects one of the control programs in accordance with a specific instruction or protocol, and executes the selected control program for said memory card.

49. The program of claim 44, said process further comprising:
monitoring an instruction or a protocol received from the external device;
selecting one of the control programs in accordance with a specific instruction or protocol; and
executing the selected control program for said memory card.

50. The memory card of claim 41, wherein:
said program memory stores:
a command judgment program for judging each content of a command from an external device;
a control program for common portions of memory cards; and
control programs dedicated to memory cards for plural standards,
the control program for common portions of memory cards is a control program for controlling data access between said nonvolatile memory and the external device as memory cards of plural standards, the control program for common portions of memory cards performing control on portions common to the memory cards of plural standards, and
the control programs dedicated to memory cards are control programs for controlling data access between said nonvolatile memory and the external device as separate memory cards, the control programs dedicated to memory cards performing control dedicated to each memory card, and
said at least one control unit judges each content of the command from the external device in accordance with the command judgment program and selects and executes one of the control program for common portions of memory cards and the control programs dedicated to memory cards for plural standards.

51. The memory card of claim 41, wherein said plurality of standards include the standards of SD card and MMC.

52. The memory card of claim 42, wherein said plurality of control units include control units for SD card and MMC.

53. The computer-readable program of claim 45, said control programs for plural standards including control programs for standards of SD card and MMC.

54. A memory card control changeover method for a memory card, said method comprising the step of selecting one of a plurality of standards to control said memory card.

55. The memory card control changeover method of claim 54, wherein said memory card includes:
a plurality of control units; and
a changeover switch such as a write protect switch,
said selecting step further comprising:
monitoring a status of a signal from said changeover switch; and
executing a designated one of the control programs for said memory card in accordance with the status of the signal.

56. The memory card control changeover method of claim 54, wherein said memory card includes:
a control unit;
a nonvolatile memory;
a changeover switch such as a write-protect switch; and
a program memory for storing control programs for plural standards, the control programs controlling data access between said nonvolatile memory and an external device as a memory card,
said selecting step further comprising:
monitoring a status of a signal from said changeover switch; and
executing a designated one of the control programs for said memory card in accordance with the status of the signal.

57. The memory card control changeover method of claim 54, wherein said memory card includes:
a control unit;
a nonvolatile memory;
a changeover switch; and
a program memory for storing control programs for plural standards, the control programs controlling data access between said nonvolatile memory and an external device as a memory card,
said selecting step further comprising:
receiving a status of a signal from said changeover switch when a specific instruction is obtained from the external device; and
executing a designated one of the control programs for said memory card in accordance with the status of the signal.

58. The memory card control changeover method of claim 54, wherein said memory card includes:
a control unit;
a nonvolatile memory; and
a program memory for storing control programs for plural standards, the control programs controlling data access between said nonvolatile memory and an external device as a memory card,
said selecting step further comprising:
monitoring an instruction or a protocol received from the external device;
selecting one of the control programs in accordance with a specific instruction or protocol; and
executing the selected control program for said memory card.

59. The memory card control changeover method of claim 54, said selecting step further comprising:
judging each content of a command from an external device; and
in accordance with the judgment, selecting and executing either:
a common control program for controlling portions common to memory cards of plural standards as a control program controlling data access between a nonvolatile memory and an external device as memory cards of plural standards; or
a single dedicated control program or a plurality of dedicated control programs for controlling dedicated to separate memory cards as a control program controlling data access between the nonvolatile memory and the external device as separate memory cards.
